(19) United States
(12) Patent Application Publication
(10) Pub. No.: US 2017/0112296 A1
(43) Pub. Date: Apr. 27, 2017

(54) ILLUMINATED DIAPER CHANGING COVER

(71) Applicant: Prince Lionheart, Inc., Santa Maria, CA (US)

(72) Inventors: Michael McConnell, Santa Maria, CA (US); Kelly McConnell, Santa Maria, CA (US)

(21) Appl. No.: 15/394,510

(22) Filed: Dec. 29, 2016

Related U.S. Application Data
(63) Continuation-in-part of application No. 15/332,661, filed on Oct. 24, 2016.
(60) Provisional application No. 62/245,187, filed on Oct. 22, 2015.

(51) Int. Cl. A47D 5/00; F21V 3/00; F21V 23/04; F21V 21/08; A47D 15/00; F21V 33/00

(52) U.S. Cl. CPC A47D 5/00; A47D 15/005; F21V 33/0012; F21V 23/04; F21V 33/0052; F21V 23/0442; F21V 21/08; F21V 3/00; F21W 2131/301

(57) ABSTRACT

A diaper changing system includes a cover to cover over any existing diaper changing pad. The system includes a light source that can be a standalone unit or it can be entirely integrated into the cover to provide lighting. An instruction is provided for a user to attach the standalone light source to either the existing diaper changing pad or to the cover.

### PRIOR APPLICATIONS

This continuation-in-part application claims priority to and incorporates by reference in its entirety non-provisional application Ser. No. 15/332,661 filed on Oct. 24, 2016 (now pending), which claims priority to provisional application No. 62/245,187 filed on Oct. 22, 2015, by the same inventor(s).

### COPYRIGHT NOTICE

One or more portions of this disclosure contain material which is subject to copyright protection. The copyright owner makes no objection to reproduction by anyone of this disclosure as disclosed in the Patent and Trademark Office files, record, or the like. Otherwise, the copyright owner reserves any and all copyright rights whatsoever for this patent disclosure. 37 CFR 1.71(d).

### BACKGROUND OF THE DISCLOSURE

The following information may be useful in a better understanding of this disclosure. Please note that information contained in this section is not an admission that the information provided is material or prior art to this disclosure or as described in claimed disclosure, or that any publication or document that is specifically, implicitly or otherwise referenced is prior art.

1. Field of the Disclosure

The present disclosure relates generally to the field of diaper changing system and more specifically relates to a novel diaper changing system that can include a cover, a pad, a light source, which can or cannot be detachable from any other parts of the system.

2. Description of the Related Art

Conventional diaper changing pads include pads, straps, support cushions, changing valets and the like.

For example, conventional diaper changing technologies include:

(1) a baby pad and mattress with a strap disposed in the middle of the mat, e.g., U.S. design Pat. No. 436281; and an infant support cushion including a V-shaped mat (or a pad with triangular sides) as disclosed in U.S. Pat. No. 6,125,487;

(2) a lamp used in diaper changing devices, for example, U.S. Pat. No. 7,810,181 and U.S. patent application publication No. US20060163236 both have lights close to the head of a baby and may include an aroma diffuser and a music playing device; and U.S. patent application publication No. US20140311843 that has a night light on an edge of a case; and China patent No. CN203000132U having two lights pointing at a baby's feet and not hurting a baby's eyes;

(3) a folding case having a diaper pad and lights disposed on a side of a case used for entertainment, such as U.S. Pat. No. 8,400,300 B2;

(4) a forced air dryer as part of a baby's diaper changing process, such as U.S. Pat. No. 6,928,235 B2;

(5) phototherapy lights including a plurality of blue lights, such as U.S. patent application publication Nos. US20080116401, and CN203777515 U, used for neonatal jaundice treatment of baby;

(6) a bottom plate of a baby incubator has a warm light, such as China patent No. CN203777515 U;

(7) a plumber's support pillow including a support cushion to provide light in front of a person, e.g., U.S. Pat. No. 7,305,728 B2, working under a sink in a cabinet;

(8) a bottom plate of an incubator, e.g., China patent No. CN203802728 U, has a warm light arranged on a base plate of the incubator (in a corner of the incubator) and can provide illumination when changing diapers; and

(9) beds or mattresses are provided with lights such as night light(s), such as China patent No. CN202020099U, China patent No. CN203882566 U, U.S. Pat. No. 4,220,984 A, U.S. Pat. No. 2,290,866, China patent No. CN203915309U, and China patent No. CN2907407Y.

None of the above disclosures and patents, taken either singly or in combination, is seen to describe the disclosure as claimed. Thus, a need exists for an improved diaper pad having any or all the following attributes, e.g., less complexity, e.g., less parts, improved diaper changing capability, e.g., longer life, better illumination, and additional features or options, or the like, e.g., provides entertainment or fun environment, within a more convenient means and ideally a smaller footprint means, e.g., compact sized design, while changing diapers and to reduce or avoid many of the above-mentioned problems.

### BRIEF SUMMARY OF THE DISCLOSURE

In view of the foregoing disadvantages inherent in the known diaper changing pads, the present disclosure provides a novel diaper changing system including a cover and an illumination source. The general purpose of the present disclosure, which will be described subsequently in greater detail, is to provide a specially designed diaper changing system utilizing a cover and an illumination source.

In one aspect, a diaper changing system is disclosed including a diaper changing cover including a main body having a head end, a foot end, marginal side edges, a front side, and a backside; a transparent or a semi-transparent portion disposed on the diaper changing cover; and a light source coupled to the diaper changing cover.

In another aspect, a method is disclosed for assembling a diaper changing system for at least one of a diaper changing pad, a table, and a substantially horizontal surface, the method comprising: providing an instruction to place a light source on top of said at least one of the diaper changing pad, the table, and the substantially horizontal surface; providing a diaper changing cover including a main body having a head end, a foot end, and marginal side edges, and said instruction teaches placing the diaper changing cover over the light source.

In another aspect, an accessory system is disclosed for a diaper changing pad comprising: a diaper changing cover including a backside, the diaper changing cover being adapted to removably attach to the diaper changing pad; and a light source coupled to the diaper changing cover.

The present disclosure holds significant improvements and serves as a diaper changing system having a cover and/or a light source. As described herein, it is to be understood that not necessarily advantages, and novel features may be achieved in accordance with any one particular embodiment of the disclosure. Thus, the disclosure can be embodied or carried out in a manner that optimizes or achieves one or a group thereof of advantages as taught herein without achieving many or all advantages as may be taught or suggested. Features of the disclosure which are believed to be novel are distinctly claimed in the specification. It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

### BRIEF DESCRIPTION OF THE DRAWINGS

The figures which accompany the written portion of this specification illustrate embodiments and method(s) of use for the present disclosure of a contoured diaper changing pad 100 according to the teachings of the present disclosure.

FIG. 1 shows a block diagram illustrating a contoured diaper changing pad 100 according to an embodiment of the present disclosure.

FIG. 2 is a top view illustrates a consumer product 200 using a main body 102 of a diaper changing pad with a series of spaced-apart, recessed LED lights 120 of 50% lower portion of the marginal side edges 108 according to an embodiment of the present disclosure of FIG. 1.

FIG. 3 is a top view illustrates a consumer product 300 using a main body 102 of a diaper changing pad with series of spaced-apart, recessed LED lights 120 of 50% lower portion 122 of the marginal side edges 108 including security straps 110 and buckles 111 according to an embodiment of the present disclosure of FIG. 1.

FIG. 4 is a top view that illustrates a consumer product 400 using a main body 102 of a diaper changing pad that includes at least one light source 118 recessed and integrated into approximately a lower half 128 from a mid-line position 126 of a main body 102 including a foot end 106 according to an embodiment of the present disclosure of FIG. 1.

FIG. 5 is a top view that illustrates a consumer product 500 using a main body 102 of a diaper changing pad with a contoured, semi-light transparent, patterned hood 130 having an edge 132 extended and attached proximal to the foot end 106 according to an embodiment of the present disclosure of FIG. 1.

FIG. 6 is a side view that illustrates a consumer product 600 for using a main body 102 of a diaper changing pad with a contoured, semi-light transparent, patterned hood 130 having an edge 132 extended and attached proximal to the foot end 106 that redirects light from the at least one light source 118 positioned approximately two thirds of a distance 134 from a mid-line position 138 of the main body 102 proximal to the foot end 106, and projects thorough its outer surface an after dark constellation scene 140 on a ceiling 142 of a room or a nursery viewable by a user on the head end 104 according to an embodiment of the present disclosure of FIG. 5.

FIG. 7 is a top view illustrating a main body 102 of a diaper changing pad including spaced apart LED display 149, 153 respectively on a foot end 106 and a head end 104 according to an embodiment of the present disclosure of FIG. 1.

FIG. 8 is a top view illustrating a diaper changing pad 100 including at least one extended light bar 151, 155 respectively on a foot end 106 and a head end 104 according to an embodiment of the present disclosure of FIG. 1.

FIG. 9 is a top view illustrating a main body 102 of a diaper changing pad with a mobile insert toy 150 located proximal to the head end 104 and the at least one light source 118 supported by a bendable, hidden, retractable and/or swivel arm 146 at the foot end 106 according to an embodiment of the present disclosure of FIG. 1.

FIG. 10 is an illustration of an embodiment where the light source is a standalone device.

FIG. 11 is an illustration where the standalone device of FIG. 10 has a base that is wedged under and/or into the diaper changing pad.

FIG. 12 is an illustration of an embodiment where the light source is a standalone device.

FIG. 13 illustrates the standalone device of FIG. 12 being placed on top of a diaper changing pad.

FIG. 14 is a block diagram showing the relationship of a light source and a switch within a diaper changing pad.

FIG. 15 is a block diagram showing the relationship of a light source, an audio device, and a switch within a diaper changing pad.

FIG. 16 is a block diagram that illustrates the diaper changing system according to an embodiment of the present disclosure.

FIG. 17 is a method that illustrates the diaper changing system according to an embodiment of the present disclosure.

FIG. 18 is a top view of a consumer product that illustrates the diaper changing system according to an embodiment of the present disclosure.

FIG. 19 is a side view of a consumer product that illustrates the diaper changing system according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present disclosure relate to the field of diaper changing pads and more specifically relates to a novel diaper changing pad with illumination where the illumination piece can or cannot be a detachable accessory.

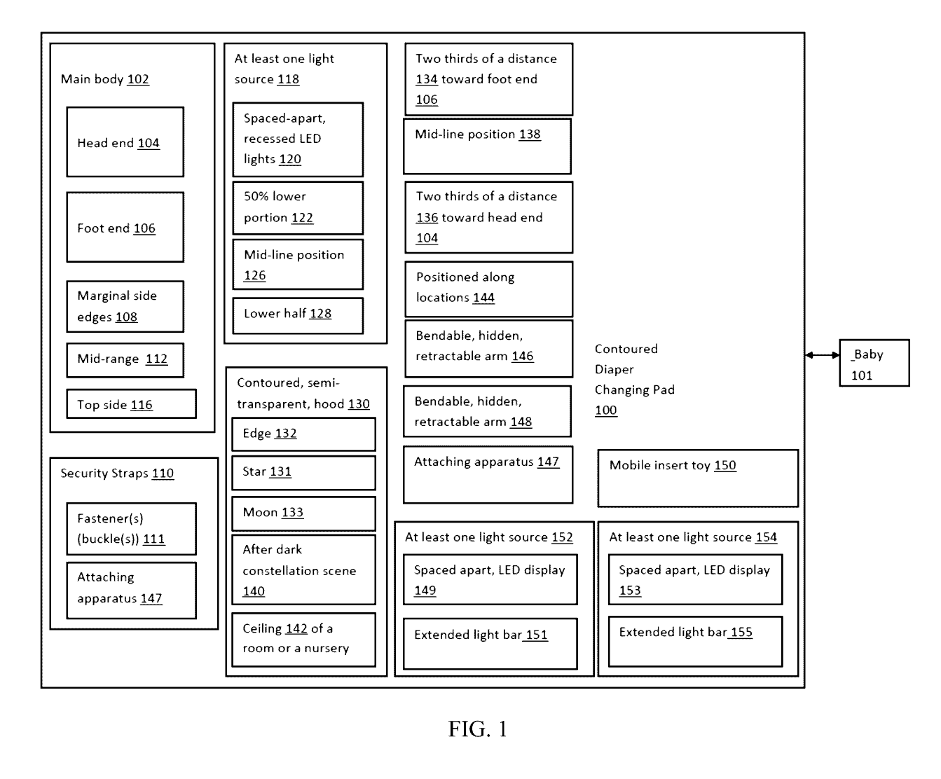

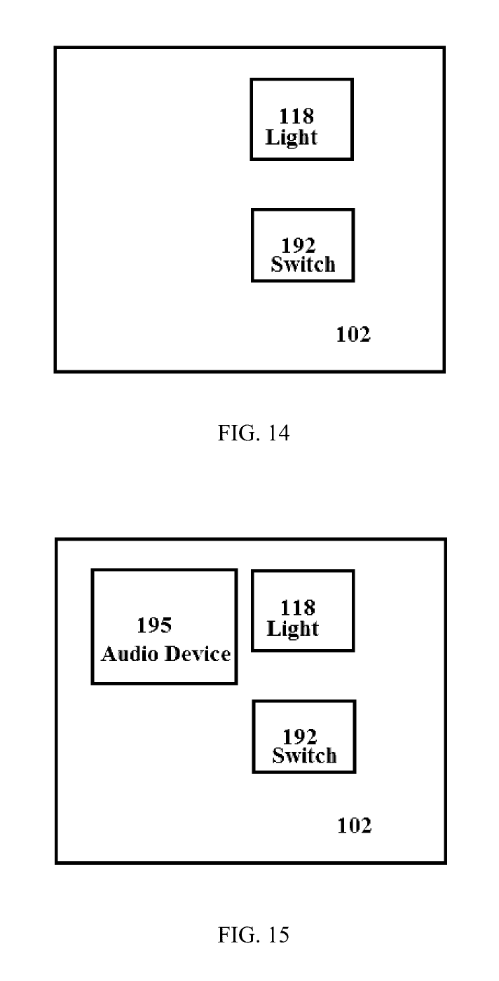

Referring to the drawings by numerals of reference there is shown in FIGS. 1-19, as discussed above, embodiments of the present disclosure relate to diaper changing systems including pads and/or covers, and a light source. Generally speaking, a diaper changing pad and a diaper changing cover is disclosed with illumination at a foot end. Advantageously, this diaper changing system provides improved illumination, e.g., ambient lighting, accent lighting, tasking lighting, and directional lighting, for users when changing diapers so that diaper changing can be performed at night, e.g., middle of the night, without turning on a room light. Advantageously, in some embodiments, the diaper changing system provides a strap to hold down the baby so the baby does not fall or slip when having a diaper change. In addition, other novel diaper changing pad and cover advantages include repositionable light source on the foot end, toys being mounted on the head end, and/or illuminated ceiling displays for a baby when changing his/her diaper on the novel diaper changing pad.

FIG. 1 shows a block diagram illustrating a diaper changing pad 100 according to an embodiment of the present disclosure.

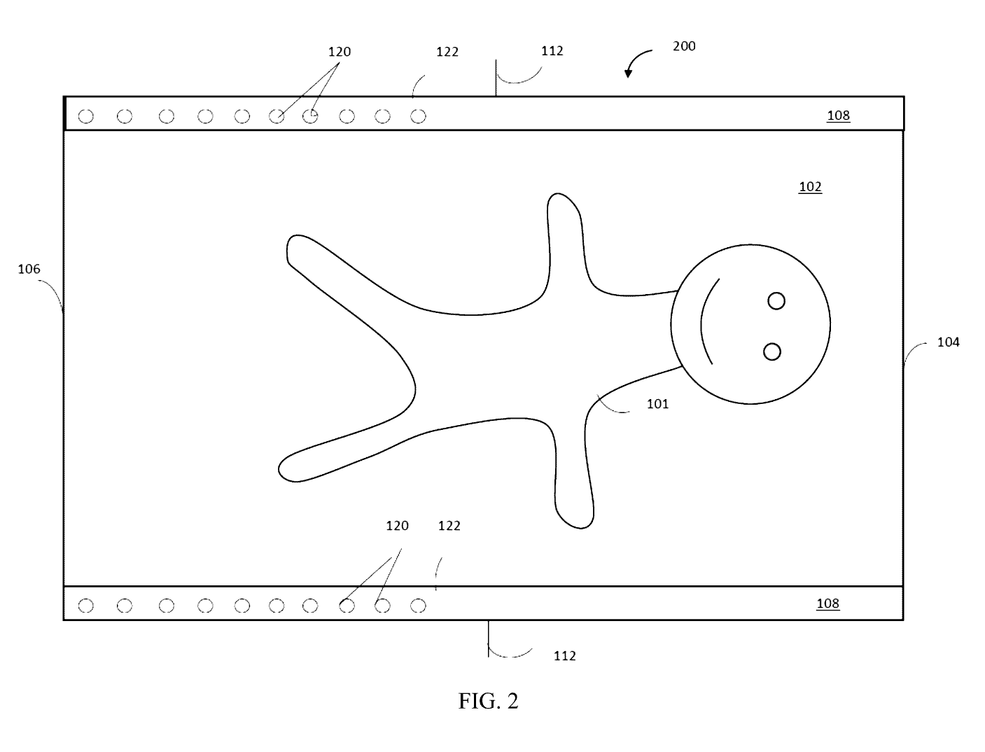

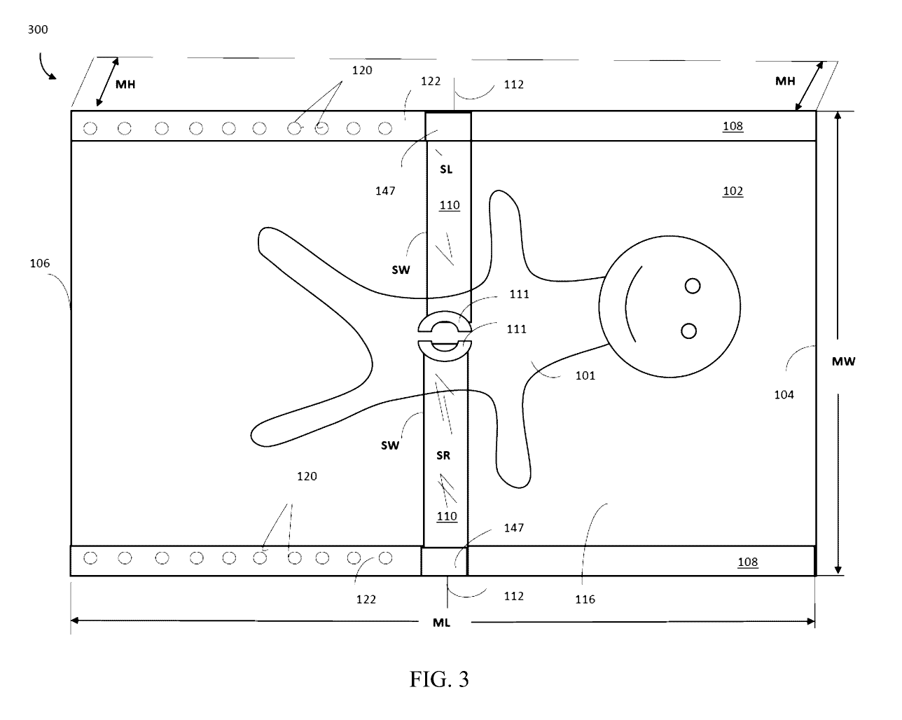

Referring now to FIG. 1, a diaper changing pad 100 is disclosed including a main body 102 having a head end 104 and a foot end 106 and marginal side edges 108. One or more light source(s) 118 are integrated within (or coupled to, or detachably attached to) the diaper changing pad 100 proximal to the foot end 106, e.g., see FIGS. 2 and 3.

One contemplated novel feature is to have at least one light source 118 disposed on the top surface of the diaper changing pad 100, wherein the light source 118 faces upward and is preferably flush with the top surface of the diaper changing pad 100 for ease of cleaning. In one contemplated embodiment, the light source 118 is not a spot light but an ambient light, so as not to cause discomfort to the person who is changing diaper on the baby and also facing the light source 118.

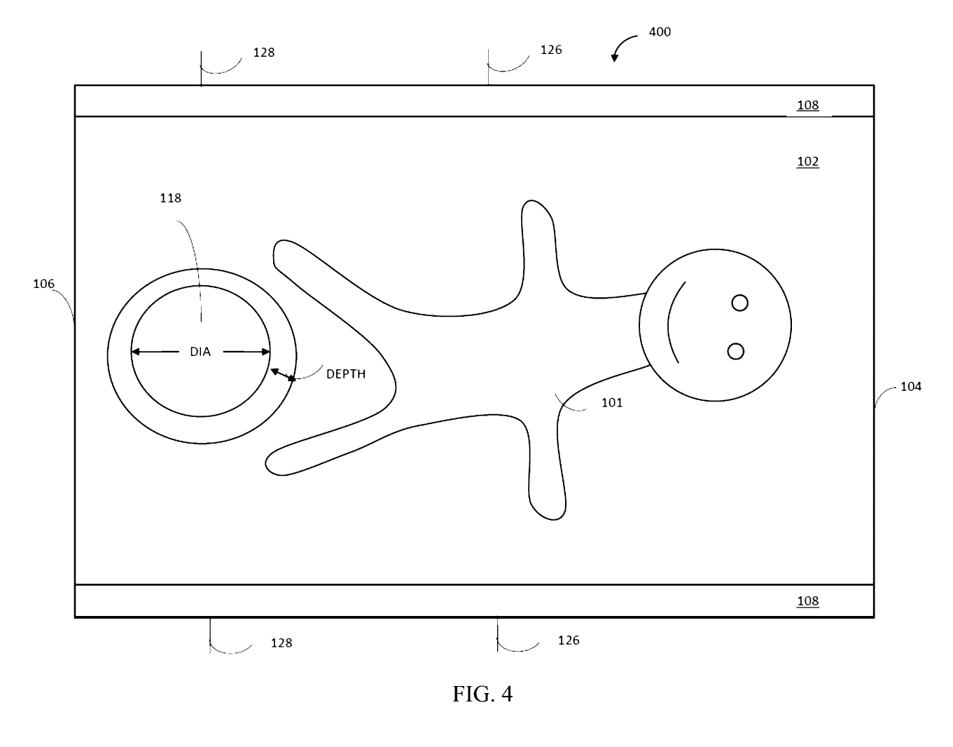

Advantageously, in some embodiments, the at least one light source 118 can includes a series of spaced-apart, recessed LED lights 120 integrated on (or coupled to, or detachably attached to) an approximately 50% lower portion 122 of the marginal side edges 108 extended proximally the foot end 106. Advantageously, by having light emitted at sides from marginal side edges 108, when changing the baby 101, the diaper does not block the light. In some embodiments, the at least one light source 118 integrated (or coupled to, or detachably attached to) includes a light source 118 disposed approximately at a lower half 128 from a mid-line position 126 of the main body 102 including the foot end 106 (such as that shown in FIG. 4).

In one exemplary embodiment, as illustrated most notably in FIGS. 3-4, there are various dimensions and locations for the at least one light source 118, the security straps 110, and the main body 102.

Although the above embodiments specifically require a series of spaced-apart, recessed LED lights, it should be noted that any types of known illuminating elements (e.g., incandescent light bulbs, or other non-LED light) in any shapes or sizes (e.g., light strips, single light, light bars) are also contemplated in the above and below described embodiments.

As illustrated throughout this disclosure, the at least one light source 118 may be recessed, flat, cylindrical, spaced apart, elongated, or the like and may be located on at least one of the foot end 106, the head end 104, and the marginal side edges 108, for example, along a 50% lower portion 122, of the main body 102.

The security straps 110 may be made of nylon, cloth, fabric, rubber, composite material or the like and may have various length(s), width(s), and thickness(es), and various fastening means, e.g., attaching apparatus 147, as necessary to conform to the main body 102 and so that the baby 101 can be safely and comfortably secured thereto.

In some embodiments, as most notably illustrated in FIG. 3, security straps 110 attach, e.g., using fasteners 111, e.g., buckles 111, approximately mid-range 112 along the marginal side edges 108 of the main body 102 and extend over a top side 116 of the main body 102, for example, securing the baby 101 during diaper changing to the diaper changing pad 100. The security straps 110 may be any attaching apparatus 147, for example, a clip, a magnet, a hook and loop fastener, or the like, for retraction, storage, and extending capability into and out and/or over the main body 102, and the attaching apparatus 147 is not limited to the examples provided herein.

The main body 102 may be various length(s), width(s), and height(s) that are necessary for comfort and security of the baby 101, for example, in accordance with room, surrounding, ambient conditions, size, length, and age of the baby, or the like.

In one exemplary example: the at least one light source 118 recessed includes a DIA=approximately 139.7 mm diameter and DEPTH=approximately 31.78 recess depth; the security straps 110 are SL (strap left)=approximately 444 mm in length and SR (strap right)=approximately 244 mm in length, and SW=approximately 25.44 mm in width; and the main body 102 include ML=approximately 787 mm in length and MW=approximately 406 mm in width and MH=approximately 101 mm in height.

In one example, most notably illustrated in FIG. 4, the middle portion of the main body 102 is contoured so that an inner portion where the baby 101 lays is lower than the marginal sides 108. In one embodiment, the middle portion of the main body 102 is approximately 38 mm in height, the marginal sides 108 are angled such that it goes from a height of approximately 38 mm (at edge of middle portion of the main body 102 and beginning of marginal side edges 108) to an approximate final height of 101 mm (at outer edges of marginal side edges 108).

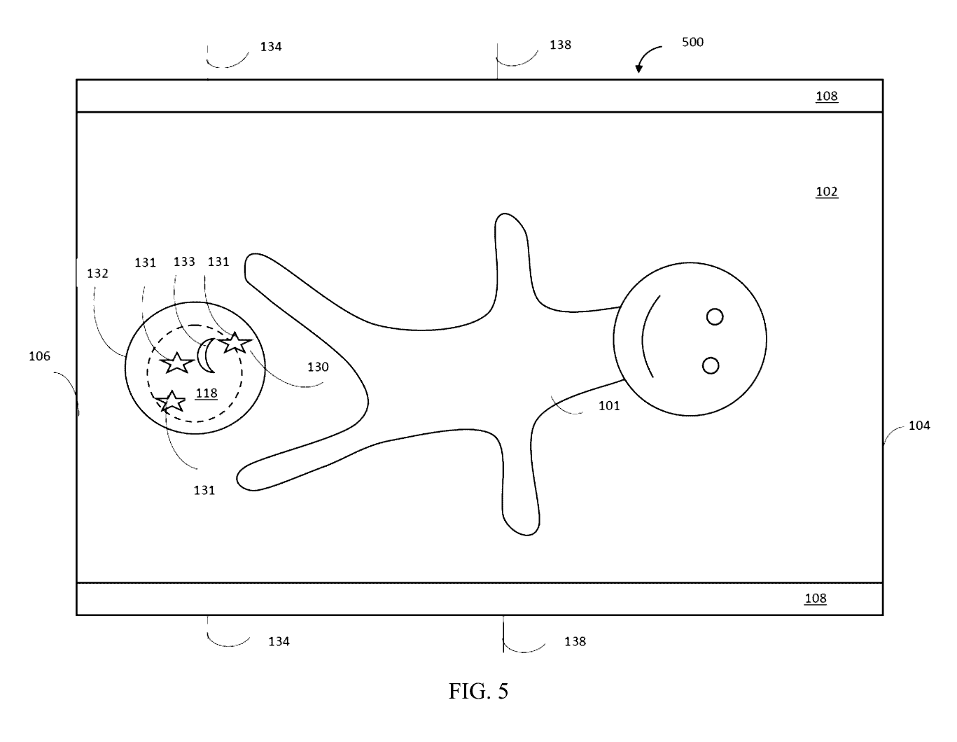

In some embodiments, such as one shown in FIG. 5, a contoured, semi-light transparent, patterned hood 130 is utilized having an edge 132 extended and attached proximal to the foot end 106.

As most notably illustrated in FIG. 5, the contoured, semi-light transparent, pattern hood 130 is, for example, color blue, and, for example, has different shaped, colored items (that are light-transparent), e.g., white stars 131, yellow colored half-moon 133, and the like, arranged on a top of the contoured, semi-light transparent, patterned, hood 130.

Advantageously, the contoured, semi-light transparent, hood 130 covers a portion of light emitted from the at least one light source 118. Advantageously, the contoured, semi-light transparent, hood 130 redirects light from the at least one light source 118 positioned approximately two thirds a distance 134 from a mid-line position 138 of the main body 102 proximal to the foot end 106.

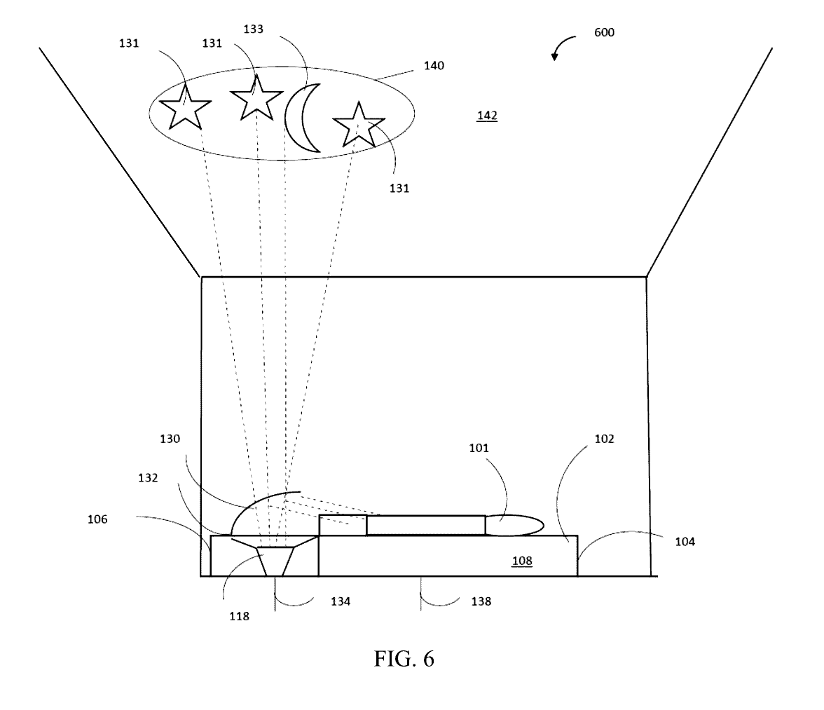

Furthermore, as most notably illustrated in FIG. 6, the contoured, semi-light transparent hood 130 projects thorough its outer surface an after dark constellation scene 140 on a ceiling 142, e.g., of a room or a nursery, viewable by a user, e.g., baby, on the head end 104.

In yet another embodiment, the semi-light transparent, hood 130 is located near the head end 104 and redirects light from the at least one light source 118 away from a user that stands near the foot end 106. There is an additional light source disposed at the foot end to illuminate the baby's bottom.

In yet another embodiment, the semi-light transparent, hood 130 can be detachably or permanently coupled to the diaper changing pad 100 at any desired location so to projects thorough its outer surface an after dark constellation scene 140 on a ceiling 142 of a room or a nursery at a user's choice.

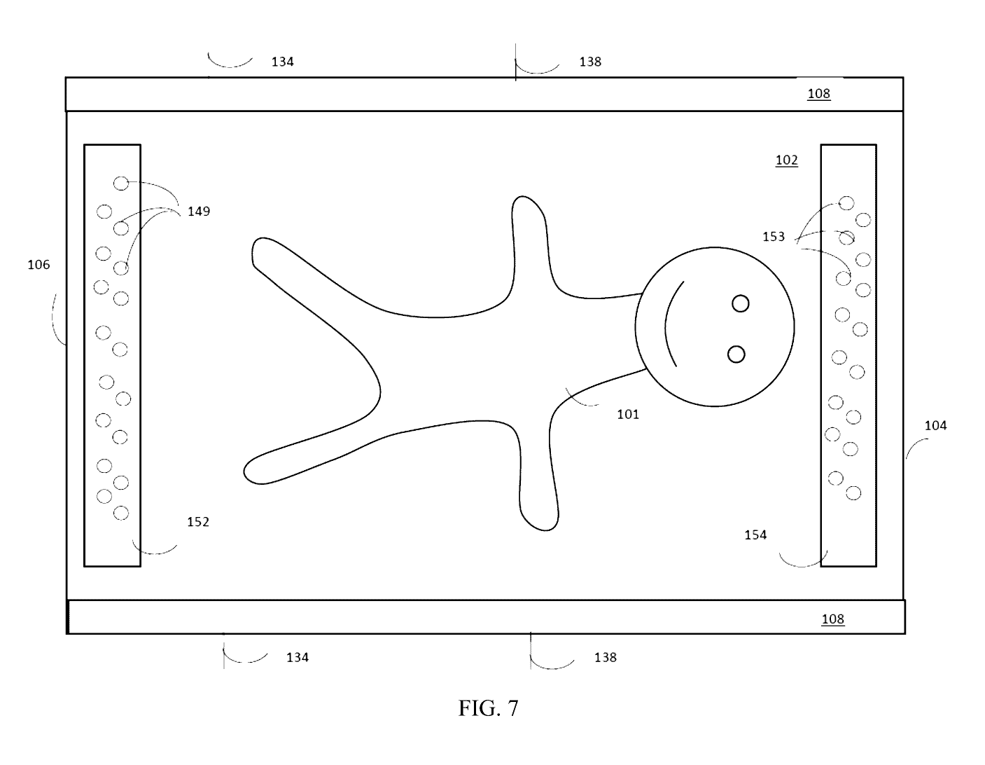

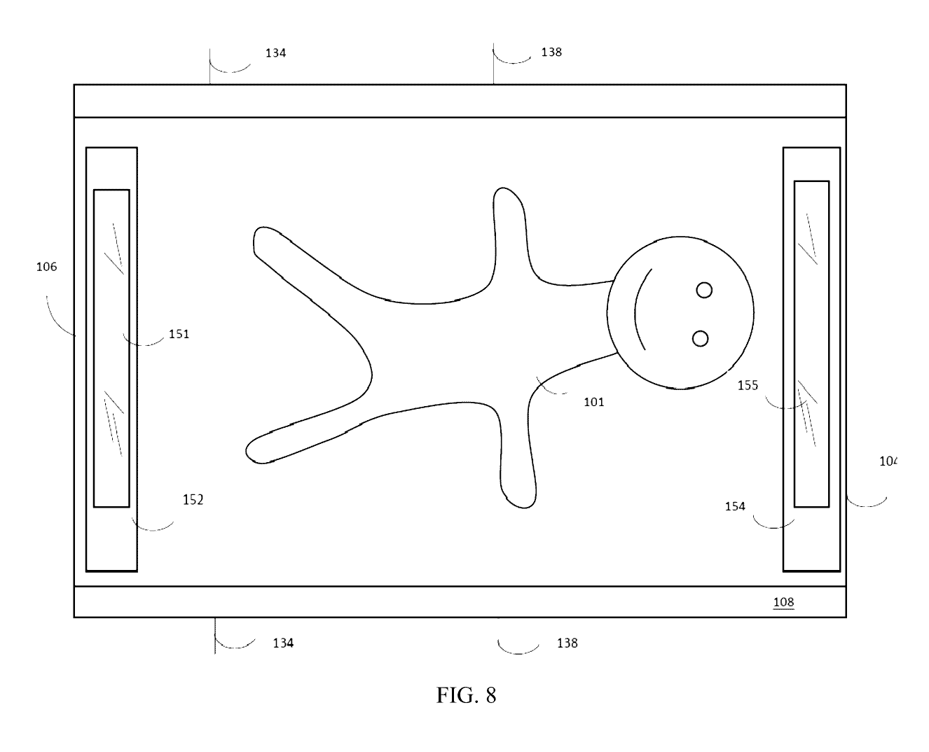

In some embodiments, as most notably illustrated in FIGS. 7 and 8, the light source includes at least one light source 152, 154, e.g., spaced-apart recessed LED lights 149, 153, extended light tube or extended light bar 151, 155, or the like, proximately attached near the foot end 106 and/or the head end 104.

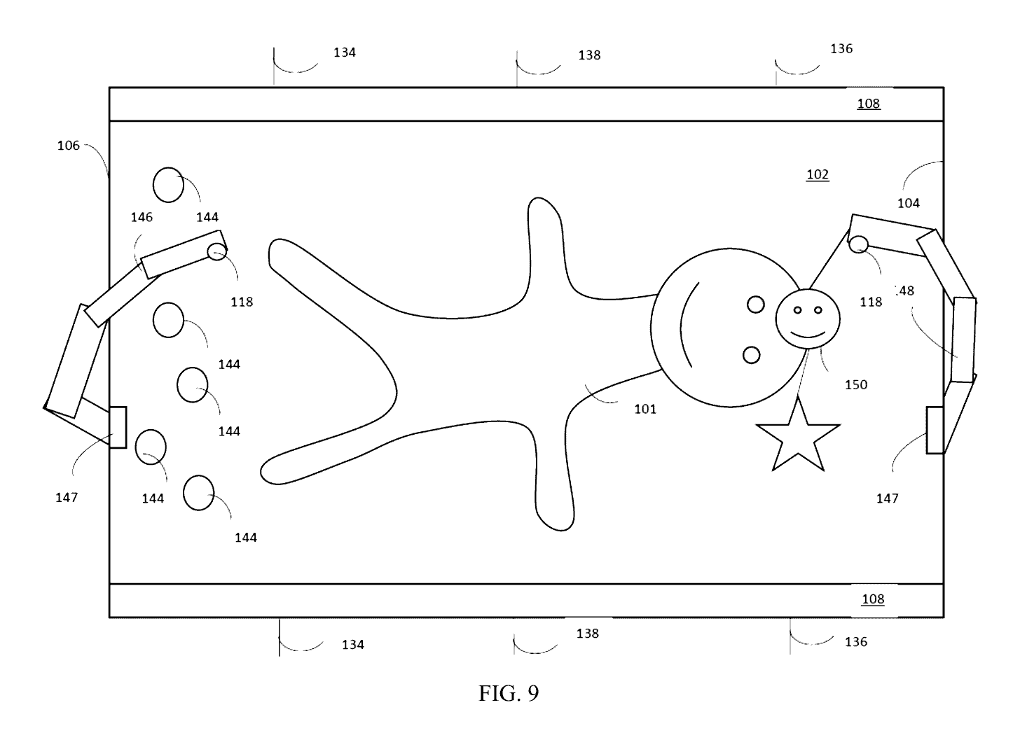

In some embodiments, as most notably illustrated in FIG. 9, a bendable, hidden, retractable arm 146 has at least one light source 118 capable of being positioned along locations 144 proximate to the foot end 106.

In some embodiments, as most notably illustrated in FIG. 9, a mobile insert toy 150 removably attaches to and dangles approximately two-thirds distance 136 from a midline position 138 of the main body 102 proximal to the head end 104.

As discussed previously, the at least one light source 118, 152, 154 can include accent lighting, tasking lighting, ambient lighting, and directional lighting.

In some embodiments, a bendable, hidden, retractable arm 146 has the at least one light source 118 that can be positioned along locations 144 proximate to the foot end 106.

In some embodiments, the bendable, hidden, retractable arm 146 including the at least one light source 118, is attached at a foot end 106 to the pad 100 by any attaching apparatus 147, for example, a clip, a magnet, a hook and loop fastener, or the like, for retraction, storage, and extending capability into and out of the main body 102, and the attaching apparatus 147 is not limited to the examples provided herein.

In some embodiments, the bendable, hidden, retractable arm 148 attached at the head end 104 to the pad 100 by any attaching apparatus 147, for example, a clip, a magnet, a hook and loop fastener, or the like, for retraction, storage, and extending capability into and out of the main body 102, and the attaching apparatus 147 is not limited to the examples provided herein.

In some embodiments, the at least one light source 152 including an extended light bar 151, spaced part LED display 149, or a like, and is positioned approximately along the foot end 106.

For example, the at least one light sources 118, 152, 154 includes accent lighting, tasking lighting, ambient lighting, and directional lighting.

In some embodiments, for example, as most notably illustrated in FIG. 9, a mobile insert toy 150 is removably attached to and dangling approximately two-thirds distance 136 from a midline position 138 of the main body 102 proximal to the head end 104. For example, the at least one light source 152 includes a directional light, e.g., extended light tube 151, spaced-apart recessed LED lights 149, or the like, proximately attached near the foot end 106.

Another aspect of the invention relates to a detachable accessory to a diaper changing pad 100. Any of the above described light sources (i.e., light bar, light bulbs, series of LED lights, light on a retractable arm, light with a hood illuminating a constellation) can be a standalone accessory that can be placed on, inserted into, adhere to, coupled to, or wedged under and/or in, any known diaper changing pad.

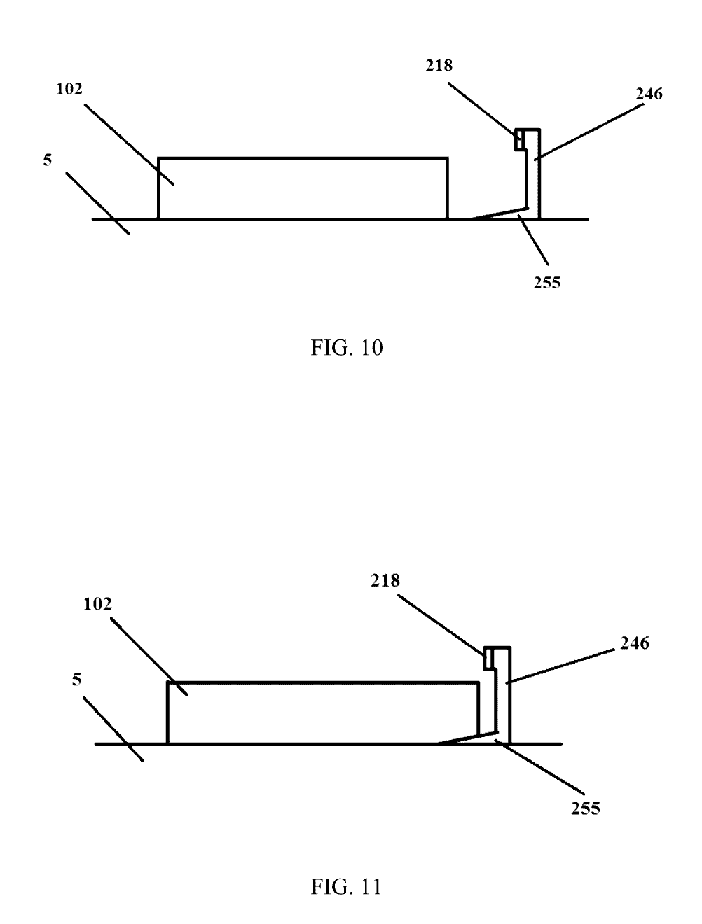

Referring now to FIG. 10, a diaper changing pad 102 is placed on top of a table 5. The standalone light accessory is placed adjacent to the diaper changing pad on the table 5. The standalone light accessory is contemplated to have a body portion 246 to which a light source 218 is coupled to. Any of the above-described light source type can be implemented. Preferably the body portion 246 is taller than the thickness of the diaper changing pad 102. The body portion 246 can be coupled to a base 255 that forwardly extends and is capable of wedging (or sliding) under the diaper changing pad 102 as shown in FIG. 11, thereby stabilizing itself by the mere weight of the diaper changing pad. Preferably the base 255 forwardly extends from the body portion 246 by at least 10 cm, more preferably by at least 15 cm, or most preferably by at least 20 cm. In this embodiment, the accessory does not require any clips or clamps to securely attach itself to the diaper changing pad. The user can freely wedge the base 255 under any side (i.e., head end side, foot end side, lateral sides) of the diaper changing pad 102 as he/she pleases to provide the most appropriate direction of lighting to change a diaper.

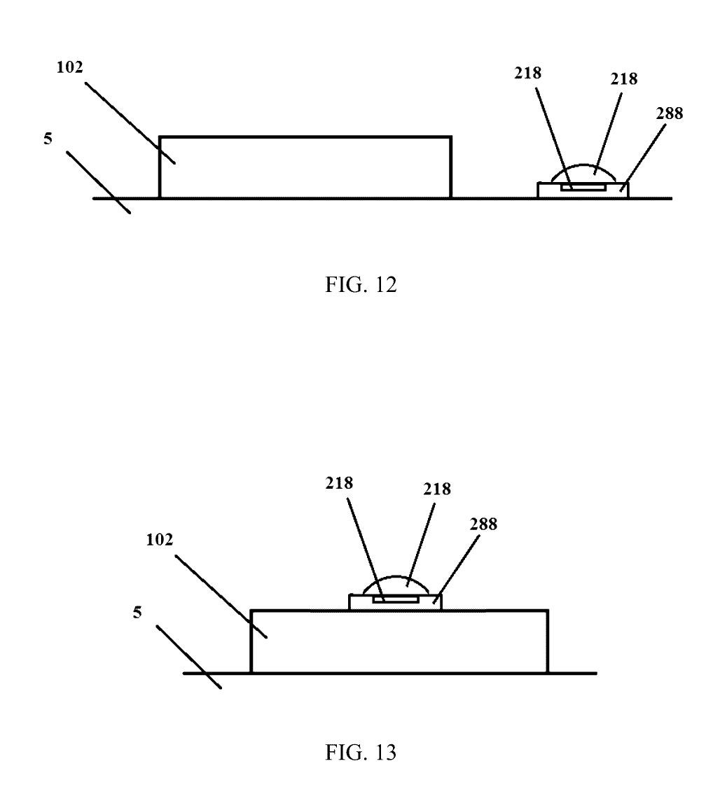

Referring now to FIGS. 12 and 13, a standalone light accessory having a housing 288 is placed next to a diaper changing pad 102. The standalone light accessory has a light source 218 and a hood 218 covering over the light source 218. A user may freely place this standalone light accessory on the top surface of the diaper changing pad 102 as shown in FIG. 13.

In other contemplated embodiments, the hood 218 as shown in FIGS. 12 and 13 can have similar construction as the embodiment shown in FIG. 6, where the hood 218 can tilt to reflect the light toward the baby. In yet another embodiment, the hood 218 as shown in FIGS. 12 and 13 can also have similar designs as the embodiment shown in FIGS. 5 and 6, where the hood 218 can have a constellation of stars or other shapes or characters, so as to project onto the ceiling to keep the baby interested.

Any embodiments of the standalone light accessory described herein can be powered by batteries, a power cord, or have recharging capabilities.

In yet another embodiment, the standalone accessory can having any mobile kit such as toy mobile, and musical mobile, as an alternative to, or in addition to, having a light source 218.

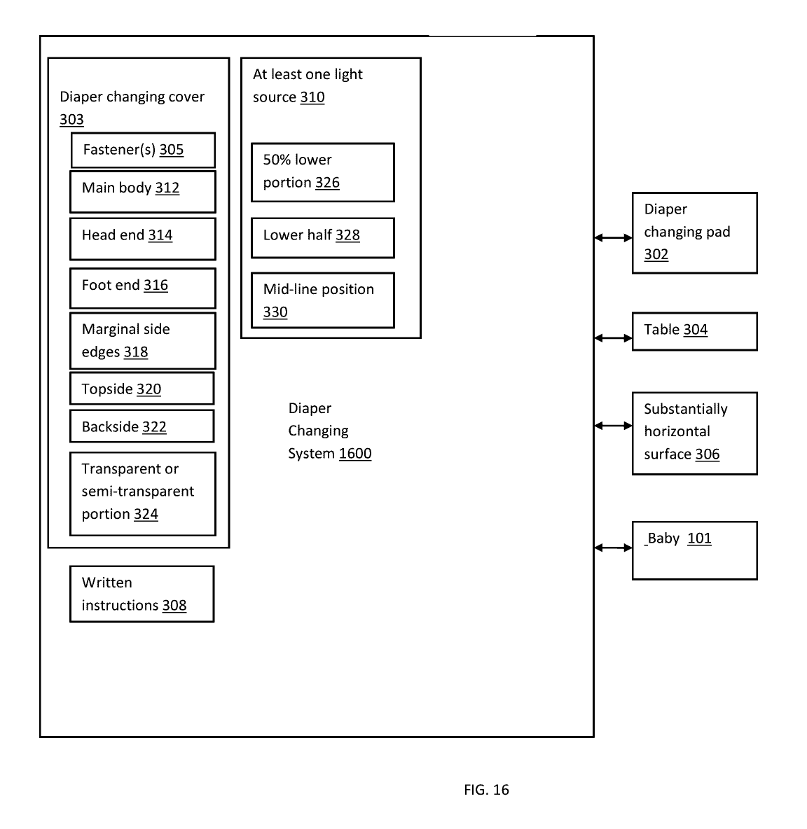

FIG. 16 is a block diagram that illustrates the diaper changing system according to an embodiment of the present disclosure.

Referring to FIG. 16, a diaper changing system 1600 is disclosed including a diaper changing cover 303 including a main body 312 having a head end 314, a foot end 316, marginal side edges 318, a front side 320, and a backside 322; a transparent or a semi-transparent portion 324 disposed on the diaper changing cover 303; and a light source 310 coupled to the diaper changing cover 303.

In one embodiment, the light source 310 is coupled to an approximately 50% lower portion 326 of the marginal side edges 318 extending to proximally the foot end 316.

In one embodiment, the light source 310 is coupled to approximately a lower half 328 from the mid-line position 330 of main body 312 including the foot end 316.

In one instance, the transparent or a semi-transparent portion 324 is at least one of a mesh, a window made of synthetic material, and a through opening, and the light source 310 (which can or cannot be a standalone unit) is coupled proximal to the backside 322 of the diaper changing cover 303 beneath the transparent or a semi-transparent portion 324.

In one instance, the light source 310 is attached to least one of a diaper changing pad 302, a table 304, and a substantially horizontal surface 306 via a fastener 305. In one instance, a written instruction 308 instructing a user to attach the fastener 305 to a top side 116 of the diaper changing pad 302. In some embodiments, the fastener 305 functions by magnets, or friction fit, or both. In some embodiments, the light source 310 has a timer to turn off the light source 310 after the light source 310 has been on for a pre-determined length of time, and further comprising a switch at the light source 310 to turn on a power source either manually or automatically.

Advantageously, in one example, the light source 310 may be adhered or be placed on top of the diaper changing pad 302, the table 304, and a substantially horizontal surface 306 and the diaper changing cover 303 placed over the light source 310.

Advantageous, in one example, by gravity, e.g., weight of diaper changing cover 303, on top of the light source 310 adheres the light source 310 to at least one of the diaper changing pad 302, the table 304, and a substantially horizontal surface 306.

Advantageous, in one example, by utilizing one or more fasteners 305 including clips, staples, nylon, magnets, cloth or plastic straps, Velcro®, double-sided adhesive or tape, or the like, placed on one or more surfaces of the light source 310, the light source 310 adheres to the diaper changing cover 303, and/or to at least one of the diaper changing pad 302, the table 304, and a substantially horizontal surface 306.

In one example, the light source 310 includes a water resistant light that is placed on top of the diaper changing cover 303.

In one example, the light source 310 is an LED light that is built in the diaper changing cover 303. In one example, the light source 310 is an LED light that is built in the diaper changing cover 303 with one or more fasteners 305 printed/attached thereon, wherein the fasteners 305, e.g., including clips, staples, nylon, magnets, cloth or plastic straps, Velcro®, double-sided adhesive or tape, or the like, attaching the light source 310 built-in a diaper changing cover 303 to at least one of the diaper changing pad 302, the table 304, and a substantially horizontal surface 306.

In some embodiments, the light source 310 is integrated into the diaper changing cover 303. In some embodiments, at least one of an audio player, a video player, or a light display coupled to the diaper changing cover 303. In some embodiments, at least one of an audio player, a video player, or a light display, is embedded within a housing of the light source 310.

In one aspect, an accessory system 1600 for a diaper changing pad 302 includes a diaper changing cover 303 including a backside 322, the diaper changing cover 303 being adapted to removably attach to the diaper changing pad 302; and a light source 310 coupled to the diaper changing cover 303.

In some embodiments, the light source 310 is integrated within the diaper changing cover 303, and further comprising a switch integrated within the diaper changing cover 303. For example, the switch is at least one of a manual switch, a timer switch, a weight sensor switch, and a motion sensor switch. The turning on and off of the light source in any of the disclosed embodiments including the standalone accessories can be by any known switches 192 (in FIG. 15), and can include proximity sensors, infrared sensors, or weight sensors. In one embodiment, when a baby is placed on the diaper changing pad, the weight sensor detects it and turns on the light source.

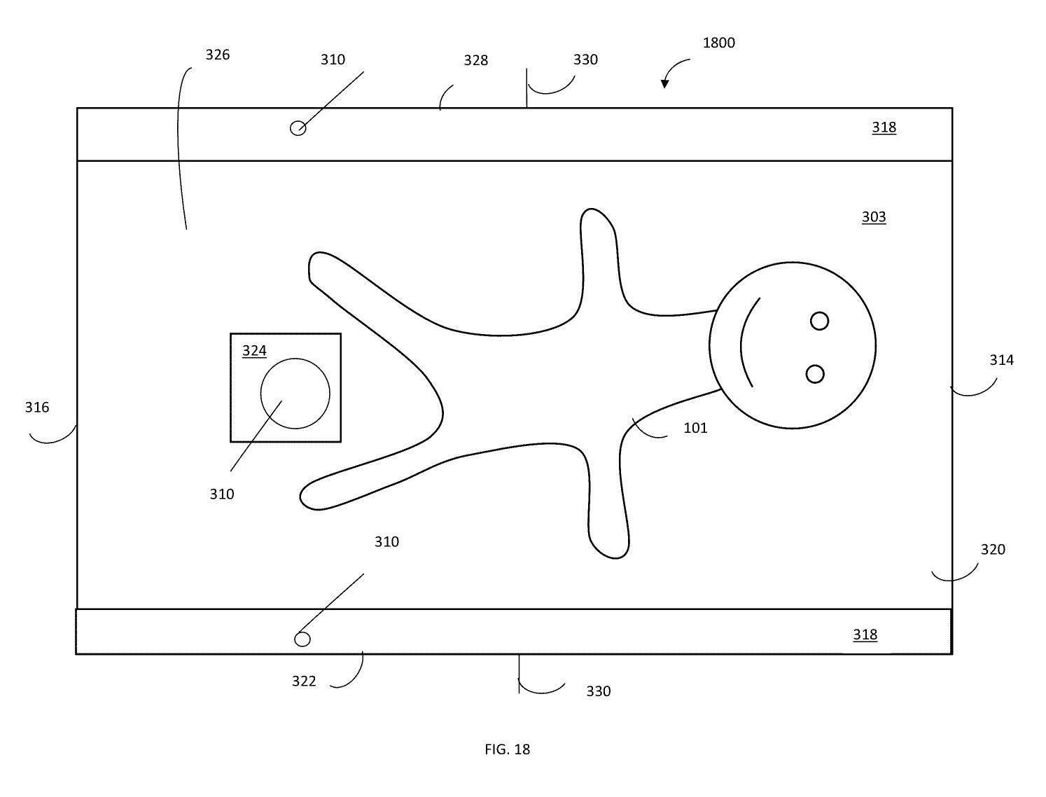

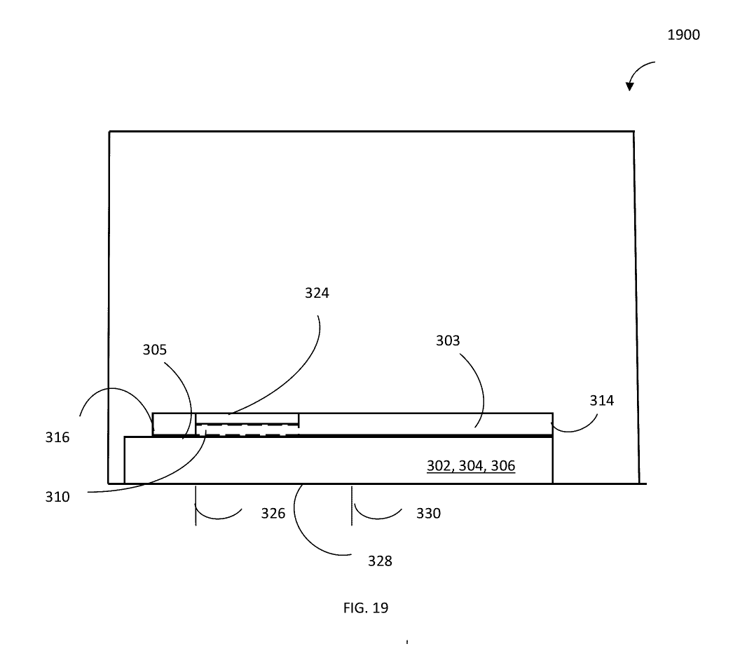

See also FIGS. 18 and 19 that are contemplated consumer products that illustrate principles of the diaper changing system and accessory system(s) 1600 of the present disclosure.

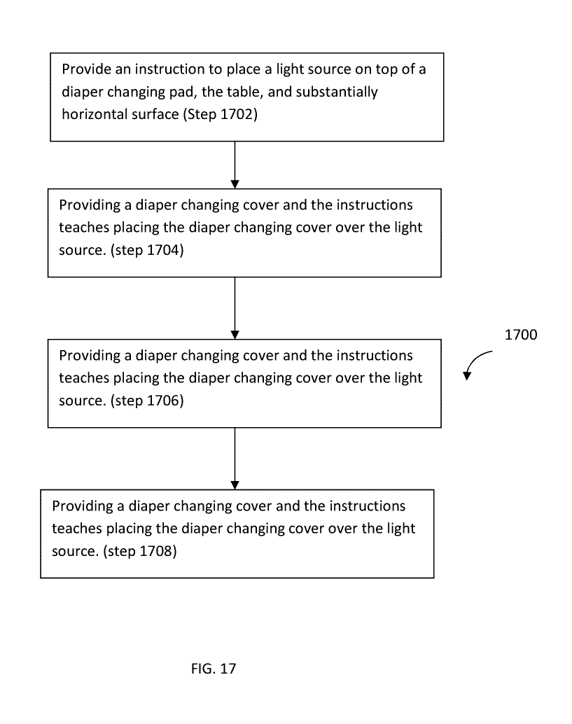

FIG. 17 is a method that illustrates the diaper changing system according to an embodiment of the present disclosure.

Referring to FIG. 17, a method 1700 is disclosed for assembling a diaper changing system 1600 for at least one of a diaper changing pad 302, a table 304, and a substantially horizontal surface 306.

In this method 1700, for example, in step 1702, providing an instruction 308 to place a light source 310 on top of said at least one of the diaper changing pad 302, the table 304, and the substantially horizontal surface 306.

Advantageously, in one example, the light source 310 may be adhered or be placed on top of the diaper changing pad 302, the table 304, and a substantially horizontal surface 306 and the diaper changing cover 303 placed over the light source 310.

Advantageously, the light source 310 may be coupled to the diaper changing pad 302 using the fastener 305 that functions by magnets, or friction fit, or both.

Advantageously, in some embodiments, the light source 310 has a timer to turn off the light source 310 after the light source 310 has been on for a pre-determined length of time, and further comprising a switch at the light source 310 to turn on a power source either manually or automatically.

Advantageous, in one example, by gravity, e.g., weight of diaper changing cover 303 on top of the light source 310 secures the light source 310 to at least one of the diaper changing pad 302, the table 304, and a substantially horizontal surface 306.

Advantageous, in one example, by utilizing one or more fasteners 305 including clips, staples, nylon, cloth, or plastic straps, Velcro®, double-sided adhesive or tape, or the like, placed on one or more surfaces of the light source 310, the light source 310 adheres to the diaper changing cover 303, which is attached to at least one of the diaper changing pad 302, the table 304, and a substantially horizontal surface 306.

In one example, the light source 310 includes a water resistant light that is placed on top of the diaper changing cover 303.

In one example, the light source 310 is an LED light that is built in the diaper changing cover 303. In one example, the light source 310 is an LED light that is built in the diaper changing cover 303 with one or more fasteners 305 attached thereon, wherein the fasteners 305, e.g., including clips, staples, nylon, cloth, or plastic straps, Velcro®, double-sided adhesive or tape, or the like, attaching the light source 310 built-in a diaper changing cover 303 to at least one of the diaper changing pad 302, the table 304, and a substantially horizontal surface 306.

In method 1700, the step 1704 includes providing a diaper changing cover 303 including a main body 312 having a head end 314, a foot end 316, and marginal side edges 318, and said instruction 308 teaches placing the diaper changing cover 303 over the light source 310.

In method 1700, the step 1706 includes aligning a transparent or semi-light transparent portion 324 of the diaper changing cover 303 with the light source 310.

In method 1700, the step 1708 includes providing in said instruction 308 a specific location on the diaper changing pad 302 to adhere to either a fastener 305 or the light source 310.

Thus far the embodiments of the standalone accessory are disclosed to be capable of being placed on, or wedged in and/or under, the diaper changing pad. In other embodiments, the standalone accessory can be detachably attached to the diaper changing pad 102 by any known methods such as by clips, magnets, by VELCRO adhesive tapes, frictional fit, and by clamps.

Throughout this specification, a diaper changing pad is sometimes described as a contoured diaper changing pad. It should be specifically noted that various shapes of the diaper changing pad are contemplated, whether with a contour top surface or without a contour top surface.

It is especially contemplated that an electronic audio device 195 can be included in any of the disclosed embodiments. This audio device 195 can include speakers to transmit sound (white noise, music, simulated sound from a mother's womb, etc.) to the baby. The content of the transmission can be made available by any known methods such as downloading, streaming, recording, rebroadcasting from an audio source via wireless transmission (e.g., BLUETOOTH), or a pre-recording embedded by the manufacturer. The location of the audio device 195 is contemplated to be anywhere on the diaper changing pad, or anywhere on the standalone accessory. Preferably, the audio device 195 is located on the top surface of the diaper changing pad near both sides of the baby's head.

Upon reading this specification, it should be appreciated that, under appropriate circumstances, considering such issues as user requirements or wishes, design considerations, marketing preferences, cost(s), structural requirement(s), available materials, technological advances, etc., other methods of use arrangements such as, for example, orders within above-mentioned list that are different, eliminated and/or additional steps, including or eliminating, for example, procedure, process, and/or maintenance step(s), etc., may be sufficient.

It should be apparent, however, to those skilled in the art that many more modifications besides those already described are possible without departing from the disclosed concepts herein. The embodiment, therefore, is not to be restricted except in the spirit of the appended claims. Moreover, in interpreting both the specification and the claims, all terms should be interpreted in the broadest possible manner consistent with the context.

In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, and as described herein are expressly contemplated as being equivalent within the scope of the claims and understood by those knowledgeable in the art. Therefore, obvious substitutions now or later known to one with ordinary skill in the art are defined to be within the scope of the defined elements and the reading of the specification as described herein.

The claims are thus to be understood to include what is specifically illustrated and described above, what is conceptually equivalent, what can be obviously substituted and also what essentially incorporates the essential idea of the embodiment. In addition, where the specification and claims refer to at least one of something selected from the group consisting of A, B, C . . . and N, the text should be interpreted as requiring only one element from the group, not A plus N, or B plus N, etc.

What is claimed is new and desired to be protected by Letters Patent is set forth in the appended claims:

1. A diaper changing system comprising:
a diaper changing cover including a main body having a head end, a foot end, marginal side edges, a front side, and a backside;
a transparent or a semi-transparent portion disposed on the diaper changing cover; and
a light source coupled to the diaper changing cover.

2. The system of claim 1, wherein the light source is coupled to an approximately 50% lower portion of the marginal side edges extending to proximally the foot end.

3. The system of claim 1, wherein the light source is coupled to approximately a lower half from the mid-line position of main body including the foot end.

4. The system of claim 1, wherein the transparent or a semi-transparent portion is at least one of a mesh, a window made of synthetic material, and a through opening, and the light source is coupled proximal to the backside of the diaper changing cover beneath the transparent or a semi-transparent portion.

5. The system of claim 1, wherein the light source is attached to least one of a diaper changing pad, a table, and a substantially horizontal surface via a fastener.

6. The system of claim 5 further comprising a written instruction instructing a user to attach the fastener to a top side of the diaper changing pad.

7. The system of claim 5, wherein the fastener functions by magnets, or friction fit, or both.

8. The system of claim 6, wherein the light source has a timer to turn off the light source after the light source has been on for a pre-determined length of time, and further comprising a switch at the light source to turn on a power source either manually or automatically.

9. The system of claim 1, wherein the light source is integrated into the diaper changing cover.

10. The system of claim 1, comprising at least one of an audio player, a video player, or a light display coupled to the diaper changing cover.

11. The system of claim 1, comprising at least one of an audio player, a video player, or a light display, embedded within a housing of the light source.

12. A method for assembling a diaper changing system for at least one of a diaper changing pad, a table, and a substantially horizontal surface, the method comprising:
providing an instruction to place a light source on top of said at least one of the diaper changing pad, the table, and the substantially horizontal surface;
providing a diaper changing cover including a main body having a head end, a foot end, and marginal side edges, and said instruction teaches placing the diaper changing cover over the light source.

13. The method of claim 11, comprising the steps of:
aligning a transparent or semi-light transparent portion of the diaper changing cover with the light source.

14. The method of claim 12, comprising the step of providing in said instruction a specific location on the diaper changing pad to adhere to either a fastener or the light source.

15. An accessory system for a diaper changing pad comprising:
a diaper changing cover including a backside, the diaper changing cover being adapted to removably attach to the diaper changing pad; and
a light source coupled to the diaper changing cover.

16. The accessory system of claim 15 further comprising a transparent or semi-light transparent portion in the diaper changing cover, wherein the transparent or semi-light transparent portion is a mesh or a window made of synthetic material.

17. The accessory system of claim 15, wherein the light source is a stand-alone unit and is coupled to the backside underneath a transparent or semi-transparent portion of the diaper changing cover.

18. The accessory system of claim 15, wherein the light source is a stand-alone unit and is fastened to a top side of the diaper changing pad.

19. The accessory system of claim 15, wherein the light source is integrated within the diaper changing cover, and further comprising a switch integrated within the diaper changing cover; wherein the switch is at least one of a manual switch, a timer switch, a weight sensor switch, and a motion sensor switch.

20. The accessory system of claim 15 further comprising a fastener to fasten the light source to the diaper changing pad, or the diaper changing cover, or both, and wherein the fastener is at least one of a magnetic fastener, a hook-and-loop fastener, a friction fit fastener, and an adhesive fastener.
